(19) United States
(12) Patent Application Publication
(10) Pub. No.: US 2025/0110499 A1
(43) Pub. Date: Apr. 3, 2025

(54) TOKENIZED VOXELS FOR REPRESENTING A WORKSPACE USING MULTI-LEVEL NETS

(71) Applicant: Intel Corporation, Santa Clara, CA (US)

(72) Inventors: Leobardo Emmanuel CAMPOS MACIAS, Guadalajara (MX); Rafael DE LA GUARDIA GONZALEZ, Teuchitlan (MX); David GOMEZ GUTIERREZ, Tlaquepaque (MX); David GONZALEZ AGUIRRE, Portland, OR (US); Julio ZAMORA ESQUIVEL, West Sacramento, CA (US)

(21) Appl. No.: 18/476,347

(22) Filed: Sep. 28, 2023

(51) Int. Cl. G05D 1/02; G06T 15/08; G06T 17/00; G06V 20/50; G06V 20/70

(52) U.S. Cl. CPC G05D 1/0274; G06T 15/08; G06T 17/00; G06V 20/50; G06V 20/70; G06T 2210/12; G06T 2210/32

(57) ABSTRACT

Disclosed herein are devices, systems, and methods for representing a workspace of a robot. The system includes a sensor configured to capture an image of the workspace. The system also includes a processor in communication with the sensor. The processor is configured to convert the image into a point cloud representation of the workspace. The processor is also configured to determine, for at least one point in the point cloud representation, a hash code that relates a task state to a volumetric space associated with the at least one point. The processor is also configured to determine a motion plan for the robot within the workspace based on the hash code and to cause the robot to execute the motion plan.

### TECHNICAL FIELD

This disclosure relates generally to representing a workspace using multilevel nets, and in particular, to workspaces in which a robot and/or human may be collaborating to accomplish tasks.

### BACKGROUND

As robots become more prevalent in our everyday lives, it becomes more important for robots to accurately, efficiently, and safely operate in their environments, especially when the environment is constantly changing and/or shared with other robots or humans. In particular, robots may need to assess the environment to identify objects and hazards in order to determine a safe, accurate, and efficient way of operating (e.g., locating an item, performing a task, moving, etc.) within the environment. As environments may change quickly and constantly, this assessment of the robot's environment may also need to be done quickly and constantly (e.g., in real-time). However, constant assessment may require numerous sensors, complex algorithms, and significant processing resources.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1A shows an example of a basic Petri-Net task description framework;

FIG. 1B shows an example of the real-world workspace in which part of the task represented by the Petri-Net of FIG. 1A may take place;

FIG. 2 illustrates an example of a system for generating and maintaining a map of tokenized voxels for a workspace in which a robot may be operating;

FIG. 3 depicts an example framework (e.g., a Petri-Net) of how tokenized voxels may be used in the context of a collaborative workspace;

FIG. 4 illustrates an exemplary schematic drawing of a device for a tokenized voxel system that relates task states to the volumetric space of a workspace; and

FIG. 5 depicts an exemplary schematic flow diagram of a method for a tokenized voxel system that relates task states to the volumetric space of a workspace.

### DESCRIPTION

The following detailed description refers to the accompanying drawings that show, by way of illustration, exemplary details and features.

The word “exemplary” is used herein to mean “serving as an example, instance, or illustration.” Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity (e.g., hardware, software, and/or a combination of both) that allows handling of data. The processor or controller may be or be part of a system-on-chip (SoC) and may consume power when handling data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, software, firmware, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information may be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radio frequency (RF) transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both “direct” calculations via a mathematical expression/formula/relationship and ‘indirect’ calculations via lookup or hash tables and other array indexing or searching operations.

A “robot” may be understood to include any type of digitally controllable machine that is designed to perform a task or tasks. By way of example, a robot may be an autonomous mobile robot (AMR) that may move within an area (e.g., a manufacturing floor, an office building, a warehouse, or other workspace etc.) to perform a task or tasks; or a robot may be understood as an automated machine with arms, tools, and/or sensors that may perform a task or tasks at a fixed location; or a combination thereof. Generally, a robot may be embodied in or as any type of machine such as a vehicle, a drone, factory machinery, etc. In addition, reference is made herein to a “human,” a “person,” or a “collaborator” that may collaborate or share a space with a robot.

As noted above, robots may need to assess the environment to identify objects and hazards in order to determine a safe, accurate, and efficient way of locating an item, performing a task, moving, or performing other operations within their environment. Given that the robot's environment may change quickly and constantly, the robot may also need to quickly and constantly (e.g., in real-time) assess its environment, which may require numerous sensors, complex algorithms, and significant processing resources. When a robot is instructed to perform tasks in a work environment (e.g., by a programmer, designer, factory foreperson, etc.), for example, it may be instructed to perform a series of tasks that depend on the state of the environment within which it is operating. For example, the robot may be collaborating with a human and the robot may be instructed to drill a hole in an item after the item is placed by a human on a worktop. The robot may then constantly monitor the worktop, wait for the item to be placed at the designated space on the worktop, and then determine a movement plan for drilling the hole in a manner that is safe, accurate, and efficient based on the current state of the environment.

To do this, the robot may receive tasks in a sematic form (e.g., a semantic task) that may be specified by the robot's programmer, designer, factory foreperson, etc., in a natural language (e.g., human instructions) with specific work requirements (WR) for the robot that may relate to the task, the movement, the workspace, etc. For example, the semantic task may be a natural language instruction such as “navigate to the conveyor belt” or “pick up package from conveyor belt” and the work requirements might involve the use of a particular tool, the use of a particular material, acting at a particular location, etc. Ensuring that the robot may perform the semantic task with the specific work requirements is often complicated in real-world scenarios, given how quickly the workspace may change, especially in human-robot collaboration tasks or when there is a wide variety of objects, tools, and materials to consider. Therefore, it may be important to have an accurate relationship between the semantic task and the work requirements. This relationship may depend on the task structure and the corresponding semantic representation of the environment. Typically, the definition of the task may involve a specialist programmer, designer, etc., that provides this relationship in a structural representation as between specific core actions and the given set of tools, materials, and robots. However, this type of fixed relationship may limit the scalability and variability of the tasks. Another approach is to automatically link the workspace components with the semantic task representation. This automatic linkage, however, often requires complex sensing, recognition capabilities, and computer processing that may impose unnecessary limits to the robot's operation and the types of possible human-robot interactions.

Disclosed below is a tokenized voxel system that links the workspace components with the semantic tasks in a far simpler way, without the need for complex sensing and computer processing. The tokenized voxel system generates identifiers (e.g., tokens) for the scene using a hash function for volumetric spaces (e.g., a voxel representation thereof) that relate the volumetric space with marked states in a task representation of the workspace. This allows fast identification of and access to the physical resources (voxels) in cartesian space. The tokenized voxel system may be used in motion planning, user interface representations (e.g., augmented reality (AR) and/or virtual reality (VR)), and other applications where it may be helpful to quickly identify the state of a workspace (e.g., physical resources, tools, obstacles, tasks, subtasks, etc.). The tokenized voxel system may utilize a camera or other imaging device (depth camera, red-green-blue (RGB) camera, infrared camera, Light Detection And Ranging LiDAR sensor, etc.) to capture images of the workspace and maintain a map or point cloud representation of the space, without the need for additional, complex sensing of the workspace.

One of the benefits of the tokenized voxel system may be that searching for physical resources may be performed at the bit-level so that the state of the workspace may be obtained directly from the hash token that uniquely identifies the point in a cartesian volumetric space. Such a tokenized voxel system may be used in combination with a task description framework, where the framework relates the current state of the workspace to the physical resources required at each stage of the task. For example, a Petri-Net framework may be used, which provides a convenient framework for marking the states of the tasks for the inputs, outputs, and transitions. Then, the tokenized voxel system may directly relate to the current state of the workspace as defined by the task description framework.

For a Petri-Net, for example, this may mean that the hash token that identifies the volumetric space is directly related to marked states in the Petri-Net. In the context of Petri-Nets, a task state is understood as a node of the Petri-Net that describes the node's status and location with respect to the task. A state transition occurs (e.g., fires) when a required set of actions for each Petri-Net node are fulfilled (e.g., the transition is enabled) so that the state may transition from one node to another node, where the required set of actions to enable a state transition may be referred to as marks or marked nodes/states of the Petri-Net. A work requirement is something that must be performed in the node to enable that state (e.g., adding a mark to the place as being ready for the state transition). In order for the state to be marked (e.g. the transition is enabled), it should be understood that marks need not necessarily be a physical asset (such as a tool, object, etc.) but the mark may represent any requirement defined by the task description (e.g., a free space, an amount of elapsed time, a movement, a photographic action, etc.). A physical resource is a physical asset in the workspace required as part of enabling a transition with a mark or node fulfillment, for example, a tool or a material. As should be understood, a node may have more than one mark. For example, a node may require the arrival of four printed circuit boards (PCBs) to trigger the transition to another state or node in the task. Thus, this would be four marks. Each mark has an identifier (ID), and the current ID of the mark, or the IDs of marks across the Petri-Net, represents the task's current state.

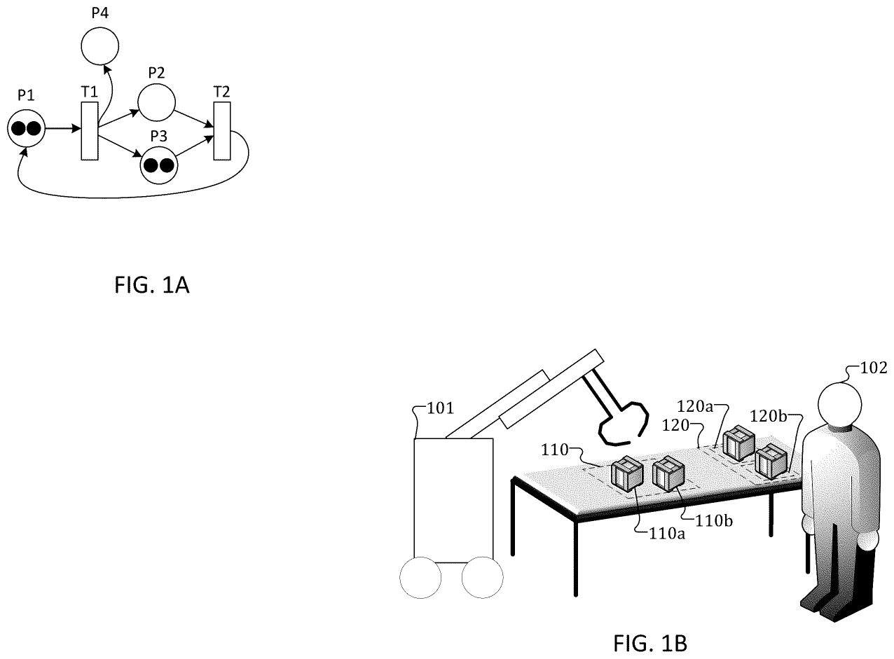

FIG. 1A shows an example of a basic Petri-Net task description framework, where the circles labeled P1, P2, P3, and P4 indicate “places,” which are inputs/outputs of the task “transitions,” labeled T1 and T2 in this example. The black dots within the circles are “tokens” that indicate a resource, event, or state that is/are, when at an input place, consumed by the transition and then creates a token at the output place. The location/distribution of tokens across the Petri-Net are a “marking” of the Petri-Net that represents the current state or configuration of the Petri-Net. Thus, in the Petri-Net example in FIG. 1A, the Petri-Net has a marking where place P1 has two tokens, P3 has two tokens, and P4 has one token. Place P1 is an input place into transition T1 while place P4 is an output place from transition T2. Places P2 and P3 are each an output place from transition T1 as well as an input place into transition T2. While Petri-Net terms may be used throughout this description and reference made to Petri-Nets, as noted above, the disclosed tokenized voxel system may be used with any type of task description framework.

FIG. 1B shows an example of the real-world workspace in which part of the task represented by the Petri-Net of FIG. 1A may take place. In this workspace, robot 101 is collaborating with a human 102. The task is for the robot 101 is to pickup blocks at physical location 110 (indicated by the dotted line), perform a task on the block, and move it to physical location 120. In the Petri-Net of FIG. 1A, transition T2 is the robot 101's processing/movement of a block from location 110 to location 120. In order to execute (or “fire”) this transition T2, two input places, namely P2 and P3, need to be enabled with to two marks/tokens (e.g., the required resource, event, or state). In this example, the token for P3 represents a required resource: a block available for processing movement by the robot at location 110. The blocks 110a and 110b are available at location 110 for movement, so two tokens are marked at P3. In addition, the token for P2 represents a different required resource: an available space on which a processed item may be placed within location 120.

As can be seen, placement location 120a and placement location 120b are both occupied, so the Petri-Net of FIG. 1A has no tokens at P2. As a result, T2 is not enabled and may not fire in the current state of the Petri-Net. Once the human 102 inspects and moves one of the blocks away from location 120, a free space becomes available and token representing this resource will appear at P2. In the Petri-Net of FIG. 1, this is represented by P1, where the token for P1 is a required resource: a block available for inspection by the human 102 at location 120. The transition T1 represents the human 102's inspection and movement of the blocks waiting at location 120, which the human 102 may approve and remove from the workspace (a token is consumed from P1 into a token at P4) or return to location 110 for picking/processing by the robot 101 (a token is consumed into a token at P3). Because, in the current state, two blocks are available for inspection at 120, there are two tokens at P1.

With a multilevel Petri-Net (MPN), such as the example Petri-Net of FIG. 1, in mind, the disclosed tokenized voxel system provides a way of defining collaborative human-robot tasks using Multi-level Petri-Net (MPN) (or any other task description frame work) that may be used to realize contextualized flows of direct commands and indirect intents directed upon feasible robot actions. Each state in the MPN may have associated items necessary to activate a transition that may be directly associated with a voxel representation by a hash key (e.g., tokens). The hash keys (or tokens) directly associate the space to, using a voxel-based representation, work-space regions, tools, materials, or anything else that the robot may use to execute the task—in other words, provides a set of tokenized voxels of the workspace.

Tokenized voxels may simultaneously describe the shape, appearance, and task markers inside the discrete event system modeled in the MPN. Tokenized voxels may provide detailed information in a task-user interface about visual, haptic, and semantic interactions. Moreover, defining the robot's tasks using tokenized voxels may provide more reliable anomaly detection because individual entities and geometric relationships between entities may be robustly tracked. In addition, tokenized voxels that fuse Petri-Net tokens with scene voxels may allow for observer-based techniques to be used directly in a sensed-model of the workspace to detect task transitions with efficient computation and high confidence. An MPN (or any other task description frame work) allows representing the actions required to trigger transitions at different levels of state resolution, which directly associates to a multi-level octree resolution of a map representation of the workspace.

The tokenized voxel representation may be used as a digital twin of a human-robot collaboration, where human(s) and robot(s) may share a workspace in which the human and robot may be collaborating towards common goal(s)/task(s) (e.g., simultaneously and/or collaboratively). The digital twin may provide task-related information to human users and sent control commands to the robots based on the state of the task and/or workspace. The digital twin may leverage an MPN in order to provide an event-based supervisory control that may be graphically represented as a new layer on a map of the workspace. Beneficially, humans may then access the same task state information as is available to the robots using a visual representation of the workspace (e.g., a voxel space multi-level relation). Moreover, the MPN may also track the state of multiple parallel subtasks and detect unexpected transitions between sub-tasks, or even anticipate failures, e.g., a depleted store, unavailability of a shared resource, etc., and trigger notification to the humans/robots or highlight critical conditions on the map. This may be monitored by, as an example, a supervisory task mapping system (STMS).

For example, the STMS may monitor, using a single sensor, a workspace in which a human and a robot are cooperating in the workspace to accomplish a task. For example, the task may be installation of a light bulb, which requires that a socket and a light bulb be placed at a goal position. An image of the scene may be represented by tokenized voxels, where the voxels may be associated with any number of properties (e.g., object identification, free-space indication, expected trajectories, etc.) that may be translated into a visual representation of the workspace. In the visual representation, for example, a color may correspond to the type of object in the physical space (e.g., the lightbulb may be colored green, the socket colored red, the location of the goal position in cyan, etc.). In addition, the voxels may be associated with an MPN representing the task(s) and the visual representation of the space may then be overlaid with the corresponding parts of the MPN (e.g., transitions, input/output places, arrows, etc.) and their associated states.

The task represented by the MPN may have a specification that describes, in each state, the correct behavior for the given state and may represent synchronizations, resources, choices, etc. In this light bulb installation example, the MPN specification may indicate that the robot that must take a socket to the goal position to complete the task. The MPN speciation may also indicate that the human must take a light bulb to the goal position to complete the task. The STMS may update a map that includes relevant properties of the voxels in the workspace so that the map may be shared with robots or humans working in the workspace and/or may be used as a basis for controlling the movements of the robots within the workspace. Humans may also directly interact with the map using AR/VR interfaces to modify the task flow. Thus, the map may be suitable for low-level motion planning for robots, allowing an end-to-end scene representation.

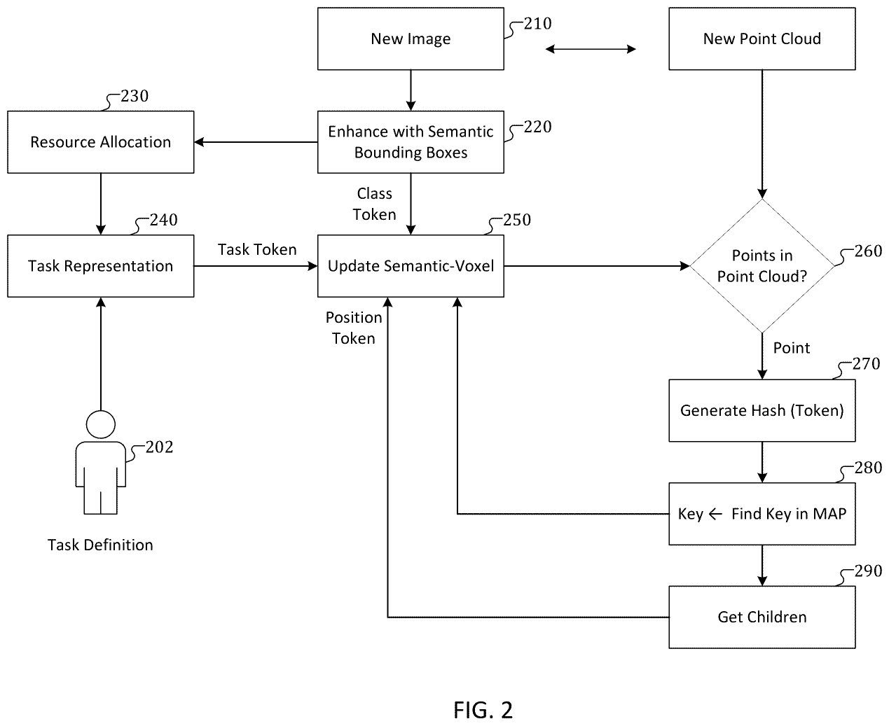

FIG. 2 depicts a system for generating and maintaining a map of tokenized voxels for a workspace in which a robot may be operating (e.g., in collaboration with a human or other robots). A camera or other image sensor(s) (e.g., a depth camera, an RGB camera, a LiDAR sensor, etc.) may be used to capture, at 210, an image/representation of the workspace. A semantic algorithm may, in 220, label the pixels regions in the image/representation of the workspace with, for example, bounding boxes. The semantic algorithm may use any number of known techniques for semantic segmentation, such as YOLO, BEIT-3, InternImage-H, among others. The semantic bounding boxes may be provided to a resource association algorithm, at 230, that associates the semantic labels with resources (e.g., by class of object) that may be used for a task of the robot. The class of object is represented in FIG. 2 by the “class token” and the variable c in the equation below that generates the hash key corresponding to the particular location of the object in the workspace. For the specific example where the sensor data is RGB-D data (e.g., from an RGB depth camera), the color pixels may be aligned with the depth image. Thus, a color pixel may be associated with each pixel in the depth frame. Then, the depth frame may be re-projected to generate a point cloud with a class association. As should be understood, the RGB-D data is just one example, but the sensor data may be from other types of sensors that provide color and depth information, such as LiDAR or different types of cameras.

The task of the robot may be configured into a semantic task representation, at 240, by a user 202 that designs tasks for the robot in the workspace. Based on the task token from the semantic task representation 240, the semantic class token from the enhanced semantic labels added by the algorithm in 220, and a position token for a cartesian coordinate may all be updated, in 250, in the map. This is possible because the class of the objects in the workspace has already been determined and the physical requirements have been specified by the multi-level semantic task representation. As such, the token task identification (“task token” in FIG. 2 and t_{c} in the equation below) may be determined for each point in the re-projected point cloud. The octree data structure may then be created with the corresponding cartesian hash to complete the key of the voxel. Ultimately, this produces a labeled point cloud of data, at 260, representing the workspace (e.g., from the image/representation and/or by converting the image/representation into a point cloud by re-projecting the pixels of the image). The point cloud of data may be used to generate a map of volumetric space related to a task state that is embedded in each point's hash (token) identifier, generated at 270, thus creating the tokenized voxels.

For each point in the point cloud, and with a maximum resolution that has been defined for each voxel, the token identifier (also called the point's hash or key) for the voxel is computed, at 270, in the form:

$$key ( x , y , z , t , c ) = cat \{ \overline{t} , \overline{x} , \overline{y} , \overline{z} \}$$

$$where :$$

$$\overline{x} = ⌊ \frac{x}{{2}^{L - 1} r} ⌋ , \qquad \overline{y} = ⌊ \frac{y}{{2}^{L - 1} r} ⌋ , \qquad \overline{z} = ⌊ \frac{z}{{2}^{L - 1} r} ⌋ , \qquad \overline{t} = ⌊ \frac{c}{{2}^{{t}_{c}}} ⌋ ,$$

In the equations above, the brackets └ ┘ indicate the floor operation. The variables x, y, z, are the cartesian point coordinates of the point in the point cloud. The semantic class was provided by the semantic algorithm (discussed above with respect to 220) and is represented by the variable c, and the unique identifier of the marker (token) associated with a physical resource in the Petri-Net is given by t_{c}. Using this relationship, the physical resources of the Petri-Net task representation are associated with a volumetric space of the work environment via the token identifier. As should be appreciated, the equations provided above is merely an exemplary relationship, and other relationships may be used to associate the task state of the Petri-Net with volumetric space.

At each stage in the task representation, there may be sub-tasks of the Petri-Net represented by marked states in the Petri-Net, highlighting only the physical resources needed for those marked states. This information may then be directly used by the low-level motion planning of the robot assistant to control the robot to reach each of the physical resources for the task or to display states in a human-user interface. A benefit of the tokenized voxel means that the relationship to the task states may be direct, without needing an exhaustive search of the workspace. It should be understood that not all of the marked states in the places/nodes of a Petri-Net will require a physical resource to trigger (e.g., fire or enable) the transition (e.g., complete the subtask). In such a case, the set of required voxels may be empty for a particular marked state. Nevertheless, the map of the workspace may be available for collision checking, motion planning, etc.

The token identifier, generated using, for example, the relationship above, may represent a 64-bit key, where 8 bits may be allocated for each spatial coordinate, and 8 bits may be allocated for the task-class representation. The generated tokens may then be pushed into an ordered list. This resulting, ordered list may provide fast access (e.g., using “shift” and “and” operations) to find, in 280, relevant voxels, based on their physical location or their associated identification node of the Petri-Net. Because the list of voxels is pushed in an ordered fashion, the function used to find physical resources may be overloaded. At each stage of the task in the Petri-Net, the marked states may return the unique tokens of the resources need to complete this given state and thus allow for a transition to other states. The needed resources may be quickly located in the list by masking the key, for example, with 0xFF000000 and then with the generated token 0xt̅000000, where

$$\overline{t} = ⌊ \frac{c}{{2}^{{t}_{c}}} ⌋ .$$

The keys that return true correspond to voxels associated with the needed physical resources, thus relating the volumetric space with the current marked states in the task description. Once voxels have been identified, the resolution may be refined by obtaining, in 290, the children based on the level of the voxel. This may be done by looking for key in the octree data structure, starting with the maximum resolution of the workspace (e.g., the entire size of the captured date representing the volume of the workspace) and then mapping the cartesian coordinates to the corresponding level. If, at this level, the key is not found, then the children of that voxel may be generated and pushed to the data structure, except for the hash in which the point is contained. From that voxel, the children may be generated again. This process may be repeated until the voxel at the minimum resolution is reached.

The children of a voxel may be referred to as the equal partition of the volumetric space into eight sub-voxels with a level of “−1.” For example, a voxel of size 1 mt×1 mt×1 mt may have eight equal voxels inside of it of 0.5×0.5×0.5, corresponding to a lower level. On the other hand, if the key is found, the semantic part of the hash key may be updated correspondingly. Also, if the hash is found but not in the minimum discretization, the previous partition steps may be performed, but this time, may start from that volume voxel.

Not only does this type of tokenized voxel allow for fast identification of needed physical resources, this may also allow for fast identification of voxels for controlling motion planning. For example, to determine whether a particular point lies inside an occupied voxel, the system may generate the point's corresponding lower portion of the identifier (cat {x̅, y̅, z̅}) and locate it in the ordered list (e.g., using similar “mask” and “and” operations). If a voxel is located/returned, this means the volume of the voxel is occupied volume; otherwise, the point lies in free space.

The tokenized voxel system may provide for Petri-Net-based intent predictions. The robot's task (e.g., the tasks for a manufacturing site) may be specified by a mathematical model that has a discrete-event component, for instance a Petri-Net as discussed above, that represents the tasks at different levels of abstraction. The specification of the task as a Petri-Net represents, at each state, the available actions that describe the correct behavior of the tasks or subtasks. The states may represent synchronizations, resources, choices, etc. The following methods may be used to provide intelligence for a robot to assist a human collaboration based on the mathematical description (Petri-Net) for the task: identification; state observer and monitoring; predication; and assistance.

With respect to identification, for some tasks, the specification may be known (e.g., defined a priori) and in other scenarios the specification may be unknown. When the specification is unknown, it may be automatically extracted from observations obtained from a person performing the task, by a process known as identification, whose aim is to provide a model (or a set of models) that is congruent with the (high-level) observations.

With respect to state observer and monitoring, the initial state of the model may be unknown, because the observation may start at any stage of the task. The state observer algorithm may determine the state of the specification from observation of the actions. The correct execution of the task may be determined if the action is consistent with (e.g., does not violate) the specification.

With respect to prediction, once the state of the specification is determined by the observer, the information for forecasting the person's actions may be indicated in the specification by assigning a probability to each of the enabled transitions in the specification, where the probability may be updated based on the observed movement, gaze, etc. of the person.

With respect to assistance, the specification may contain components that may be performed in parallel, as well as information on synchronizations, e.g., resources needed to enable a transition. Assistance may be provided by identifying the parallel component where the robot may work, toward providing, for example, the resource that will be needed in a future action by the user. As should be understood, care may need to be taken with respect to assistance because the actions of the robot may block the task and lead to, for example, a deadlock situation.

The tokenized voxel system may provide a user interface for interacting with a digital twin of the workspace using the tokenized voxels. As noted above, a map representing a workspace in which a robot and human may be collaborating (e.g., a human robot collaboration (HRC)) may need to be updated continuously due to the likelihood that the scene changes constantly. The updates may be based on information collected from any number of sensors that may be part of the robot or infrastructure of the workspace. In order to be effective, the map should reflect as accurately as possible the current state of the workspace in relation to the task. As should be appreciated, a robot may need different types of maps with different information, such as geometric maps, topological maps, semantic maps, etc., in order to operate and perform its required tasks. For example, movement planning, movement coordination, avoiding collisions, safe decision making, etc. Each of these different maps may share the same underlying data structure but may be tailored according to the capabilities and objectives of each of the different robots. The tokenized voxel map discussed above may supplement these maps and may add a supervisory task layer representation. Data from the tokenized voxel system discussed above may be used for initializing and terminating tasks, transitioning between subtasks, synchronizing and coordinating actions, etc. The map thus determined by the tokenized voxel may contains the information needed by a robot to operate efficiently in a shared workspace and when coordinating and collaborating with other robots/humans.

The tokenized voxel map may be stored at a central server that collects and fuses updates from multiple robots in order to infer the state of the task and sub-tasks. The central server may provide an updated map reflecting the current state of the workspace to the robots in the workspace (e.g., broadcasted). The robots within the workspace may then have a consistent map that each robot may use to plan actions. To achieve this objective, areas of the map may be marked, including the location of agents, material, tools, etc., that may be helpful for task execution. The markings may graphically represent how the markings relate to one other and with respect to the task. The markings may allow for communicating efficiently constructed messages to the robots describing those dynamic components. The supervisory task mapping subsystem (STMS), discussed above, may include a map storage, together with a map updating module and a message handling module. The STMS may maintains the map on an external server (e.g. a cloud-based server) that is based on prior information from a preloaded static map of the workspace as well as from new and recent information obtained from sensors and from communication with robots in the workspace. The STMS may also exchange information with a dynamic occupancy grid or similar tools used for tracking moving objects. The map may be represented as a hierarchical data structure (e.g., a voxel or an octree, with L levels and with axes-aligned bounding boxes).

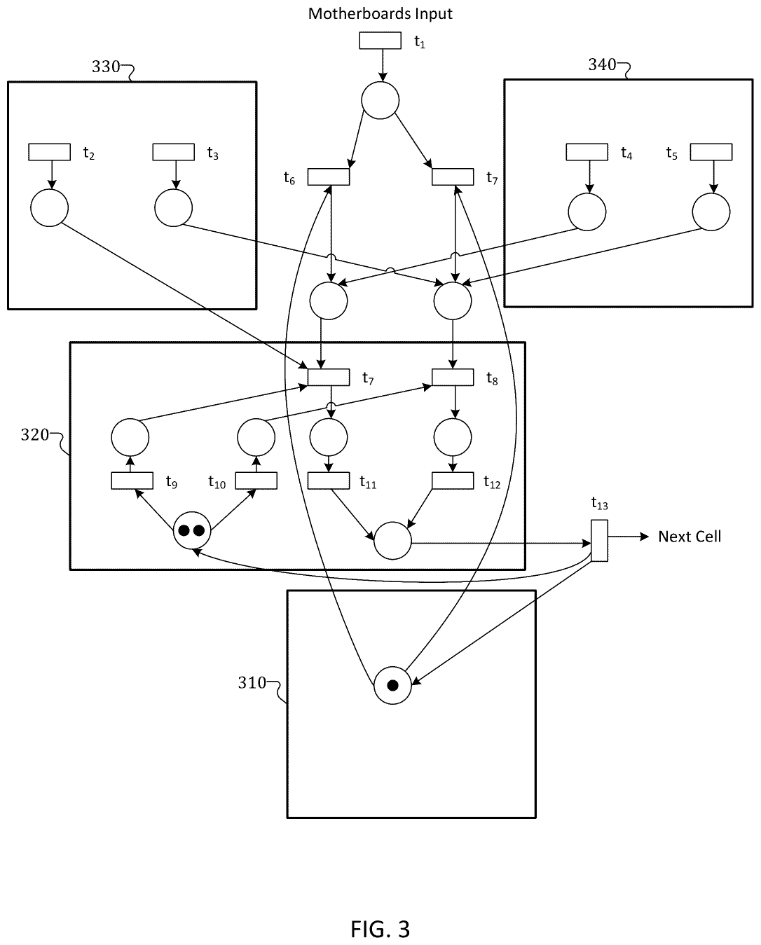

Discussed below with respect to FIG. 3 is an example framework (e.g., a Petri-Net) of how tokenized voxels may be used (e.g., by an STMS) in the context of a workspace where a robot and human are collaborating to validate motherboards. Two types of motherboards may be validated, each of which requires installing a different type of central processing unit (CPU) and a different type of memory. Area 330 and Area 340 represent respective locations of the supplies of CPUs and memories. These are managed by the robot collaborator. Area 310 represents the availability of the human to perform a validation test on the motherboard. Area 320 represents the testing unit, which provides a power supply, testing software, a human-user interface, etc.

In FIG. 3, an arrival of a motherboard is represented by the execution of transition t₁. Once the human collaborator chooses one of the motherboards in the buffer, the type of motherboard is automatically detected. To validate the selected motherboard, two resources are needed: a CPU and a memory (each of the specific type that corresponds to the selected type of motherboard). Because the task is modeled by a Petri Net, the robot has been instructed as to what resources are needed and how to assist the human. In particular, the robot has been instructed to provide the correct CPU type and memory type for the selected motherboard. The correct placement of CPUs for a motherboard of type A (or, respectively, type B) is represented by transitions t₂ (respectively, for type B, t₃), whereas the correct placement of memories is represented by transitions t₄ (respectively, for type B, t₅). Enabling the testing unit is represented by transitions to (respectively, for type B, t₁₀). Once the CPU and memory are in place, and the testing unit is enabled, the start of the test is represented by transitions t₇ (respectively, for type B, t₈). The end of the test is represented by transitions t₁₁ (resp. t₁₂). Once the test is completed; the human may label the motherboard as “passed” or “failed” and the motherboard is sent to the next cell, where the CPU and the memory are removed from the motherboard by the robot in case a motherboard failed the testing.

Using this framework of FIG. 3, the workspace may be mapped using tokenized voxels as discussed above. Thus, the objects such as memories, CPUs, and testing units, etc. are voxelized and classified with semantic information and the system generates a unique token (or hash) that associates each model with a physical item in the framework workflow of FIG. 3. Then, depending on the motherboard type, the robot may plan the trajectory towards the location of the motherboard using the map representation of the workspace without extra processing and without extra sensors. Also, depending on the motherboard type, this triggers which type of memory and CPU the robot must install in the motherboard for testing. Thus, the robot generates a trajectory to place the CPU in its socket and then to place the memory in its slot. After the CPU and memory are placed, the human enables the testing unit and starts the test. As should be appreciated, the tokenized voxel provides a synergistic combination of task representation by a Petri-Net framework and a voxelized representation of the workspace that quickly and easily ties the task state to the objects in the workspace that belong to each state of the Petri-Net.

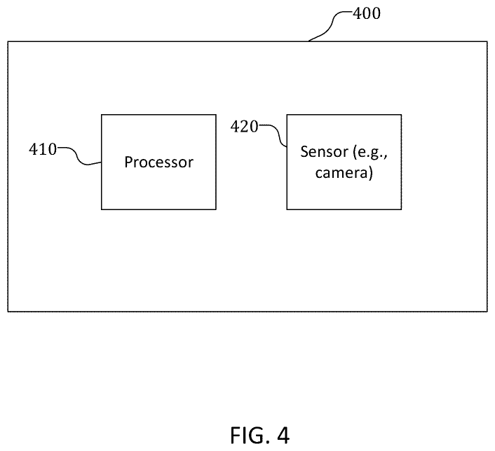

FIG. 4 is a schematic drawing illustrating a device 400 for a tokenized voxel system that relates task states to the volumetric space of a workspace. The device 400 may include any of the features discussed above with respect to tokenized voxels. FIG. 4 may be implemented as a device, a system, a method, and/or a computer readable medium that, when executed, performs the features of the tokenized voxel system described above. It should be understood that device 400 is only an example, and other configurations may be possible that include, for example, different components or additional components.

Device 400 includes a sensor 420 configured to capture an image of a workspace. Device 400 also includes a processor 410 in communication with the sensor 420, the processor 410 is configured to convert the image into a point cloud representation of the workspace, wherein the at least one point in the point cloud representation may have a corresponding classification. The processor 410 is also configured to determine, for at least one point in the point cloud representation, a hash code that relates a task state to a volumetric space associated with the at least one point. Processor 410 is also configured to determine a motion plan for the robot within the workspace based on the hash code. Processor 410 is also configured to cause the robot to execute the motion plan.

Furthermore, in addition to or in combination with any of the features described in this or the preceding paragraph with respect to device 400, the volumetric space may include a grouping of one or more points in the point cloud representation, wherein the grouping is represented by a voxel. Furthermore, in addition to or in combination with any of the features described in this or the preceding paragraph, the point cloud representation may be divided into a plurality of voxels, wherein the voxel may be one of the plurality of voxels, wherein each of the plurality of voxels may include a multilevel octree. Furthermore, in addition to or in combination with any of the features described in this or the preceding paragraph, the voxel may represent a portion of physical space within the workspace, wherein the voxel may be defined by a cartesian coordinate, a bounding box, and/or a level of the voxel. Furthermore, in addition to or in combination with any of the features described in this or the preceding paragraph, the point cloud representation may be three-dimensional.

Furthermore, in addition to or in combination with any of the features described in this or the preceding two paragraphs with respect to device 400, the task state may relate to a work requirement of a multilevel task representation framework (e.g., a Petri-Net). Furthermore, in addition to or in combination with any of the features described in this or the preceding two paragraphs, the multilevel task representation framework may include a multilevel Petri-Net, wherein the task state is represented by a configuration of mark on the multilevel Petri-Net. Furthermore, in addition to or in combination with any of the features described in this or the preceding two paragraphs, the multilevel Petri-Net may represent input places, output places, and transitions for a task in the workspace, wherein the configuration of marks may be on the input places and output places. Furthermore, in addition to or in combination with any of the features described in this or the preceding two paragraphs, the configuration of marks may include a set of input or output requirements within the multilevel Petri-Net. Furthermore, in addition to or in combination with any of the features described in this or the preceding two paragraphs, the set of input or output requirements may be described by a subtask, wherein the subtask may be associated with a physical resource needed for the subtask.

Furthermore, in addition to or in combination with any of the features described in this or the preceding three paragraphs with respect to device 400, the sensor 420 may be a visual camera, a depth camera, an infrared camera, or a LiDAR sensor. Furthermore, in addition to or in combination with any of the features described in this or the preceding three paragraphs, the motion plan may be based directly on the hash code. Furthermore, in addition to or in combination with any of the features described in this or the preceding three paragraphs, the workspace may include a collaboration space as between the robot and a human. Furthermore, in addition to or in combination with any of the features described in this or the preceding three paragraphs, the hash code may include a multi-bit key, wherein a first portion of bits of the multi-bit key may represent the task state wherein a second portion of the multi-bit key may represent the volumetric space. Furthermore, in addition to or in combination with any of the features described in this or the preceding three paragraphs, the multi-bit key may include a 64-bit key, wherein the first portion may include 8 bits of the 64-bit key and the second portion may include another 8-bits of the 64-bit key.

Furthermore, in addition to or in combination with any of the features described in this or the preceding four paragraphs with respect to device 400, the hash code may be a unique hash code that uniquely identifies one of the points in the point cloud representation. Furthermore, in addition to or in combination with any of the features described in this or the preceding four paragraphs, the volumetric space may have an associated semantic classification. Furthermore, in addition to or in combination with any of the features described in this or the preceding four paragraphs, the associated semantic classification may include a class token, a task token, and/or a position token of the at least one point. Furthermore, in addition to or in combination with any of the features described in this or the preceding four paragraphs, the processor 410 configured to determine the hash code may include the processor 410 configured to concatenate results from a plurality of functions that are based on a level of a voxel that represents the volumetric space, a cartesian coordinate of the voxel, the task state, a semantic classification associated with the volumetric space, and/or a unique identifier of a physical resource of the workspace.

Furthermore, in addition to or in combination with any of the features described in this or the preceding five paragraphs with respect to device 400, the motion plan may include a safe trajectory for the robot within the workspace. Furthermore, in addition to or in combination with any of the features described in this or the preceding five paragraphs with respect to device 400, hash codes may be stored (e.g., in a memory) as a map of the workspace, wherein each hash code may be stored with a semantic classification for the at least one point that is associated with the volumetric space and/or the task state.

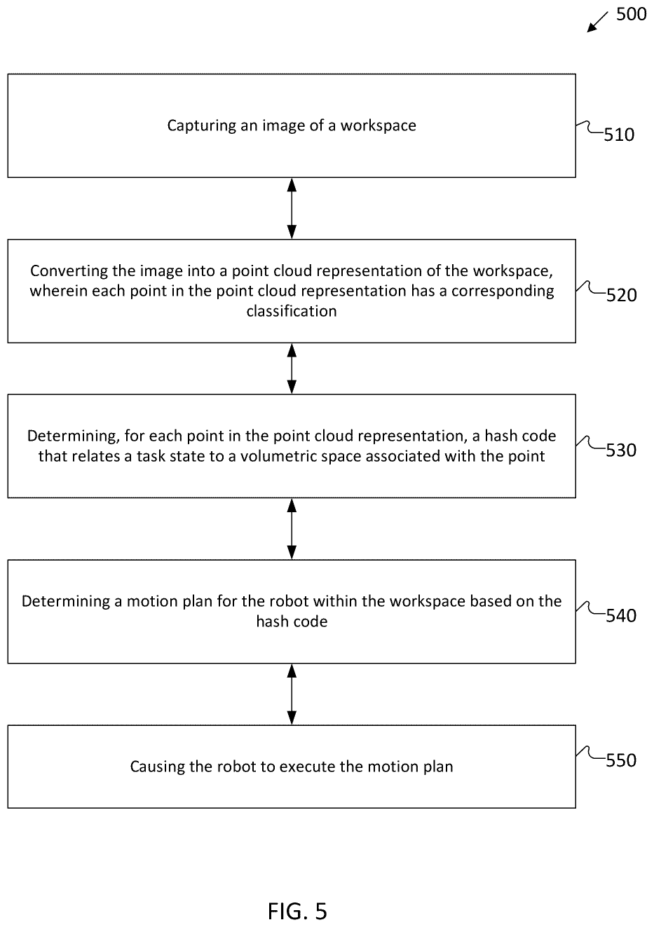

FIG. 5 depicts a schematic flow diagram of a method 500 for a tokenized voxel system that relates task states to the volumetric space of a workspace. Method 500 may implement any of the features discussed above with respect to a tokenized voxel system that relates task states to the volumetric space of a workspace. Method 500 includes, in 510, capturing an image of a workspace. Method 500 also includes, in 520, converting the image into a point cloud representation of the workspace. Method 500 also includes, in 530, determining, for at least one point in the point cloud representation, a hash code that relates a task state to a volumetric space associated with the at least one point. Method 500 also includes, in 540, determining a motion plan for the robot within the workspace based on the hash code. Method 500 also includes, in 550, causing the robot to execute the motion plan.

In the following, various examples are provided that may include one or more aspects described above with reference to the tokenized voxel system discussed above. The examples provided in relation to the devices may apply also to the described method(s), and vice versa.

Example 1 is a system for representing a workspace of a robot, the system including a sensor configured to capture an image of the workspace. The system also includes a processor in communication with the sensor, the processor configured to convert the image into a point cloud representation of the workspace. The processor is also configured to determine, for at least one point in the point cloud representation, a hash code that relates a task state to a volumetric space associated with the at least one point. The processor is also configured to determine a motion plan for the robot within the workspace based on the hash code. The processor is also configured to cause the robot to execute the motion plan.

Example 2 is the system of example 1, wherein the volumetric space includes a grouping of one or more points in the point cloud representation, wherein the grouping is represented by a voxel.

Example 3 is the system of example 2, wherein the point cloud representation is divided into a plurality of voxels, wherein the voxel is one of the plurality of voxels, wherein each of the plurality of voxels includes a multilevel octree.

Example 4 is the system of any one of examples 2 or 3, wherein the voxel represents a portion of physical space within the workspace, wherein the voxel is defined by a cartesian coordinate, a bounding box, and a level of the voxel.

Example 5 is the system of any one of examples 1 to 4, wherein the point cloud representation is three-dimensional.

Example 6 is the system of any one of examples 1 to 5, wherein the task state relates to a work requirement of a multilevel task representation framework (e.g., a Petri-Net).

Example 7 is the system of example 6, wherein the multilevel task representation framework includes a multilevel Petri-Net, where the task state is represented by a configuration of mark on the multilevel Petri-Net.

Example 8 is the system of example 7, wherein the multilevel Petri-Net represents input places, output places, and transitions for a task in the workspace, wherein the configuration of marks is on the input places and output places.

Example 9 is the system of any one of examples 7 or 8, wherein the configuration of marks includes a set of input or output requirements within the multilevel Petri-Net.

Example 10 is the system of example 9, wherein the set of input or output requirements is described by a subtask, wherein the subtask is associated with a physical resource needed for the subtask.

Example 11 is the system of any one of examples 1 to 10, wherein the sensor includes a visual camera, a depth camera, an infrared camera, or a LiDAR sensor.

Example 12 is the system of any one of examples 1 to 11, wherein the motion plan is based directly on the hash code.

Example 13 is the system of any one of examples 1 to 12, wherein the workspace includes a collaboration space as between the robot and a human.

Example 14 is the system of any one of examples 1 to 13, the hash code includes a multi-bit key, wherein a first portion of bits of the multi-bit key represents the task state wherein a second portion of the multi-bit key represents the volumetric space.

Example 15 is the system of example 14, wherein the multi-bit key includes a 64-bit key, wherein the first portion includes 8 bits of the 64-bit key and the second portion includes another 8-bits of the 64-bit key.

Example 16 is the system of any one of examples 1 to 15, wherein the hash code is a unique hash code that uniquely identifies one of the points in the point cloud representation.

Example 17 is the system of any one of examples 1 to 16, wherein the volumetric space has an associated semantic classification.

Example 18 is the system of example 17, wherein the associated semantic classification includes a class token, a task token, and/or a position token of the at least one point.

Example 19 is the system of any one of examples 1 to 18, wherein the processor configured to determine the hash code includes the processor configured to concatenate results from a plurality of functions that are based on a level of a voxel that represents the volumetric space, a cartesian coordinate of the voxel, the task state, a semantic classification associated with the volumetric space, and/or a unique identifier of a physical resource of the workspace.

Example 20 is the system of any one of examples 1 to 19, wherein the motion plan includes a safe trajectory for the robot within the workspace.

Example 21 is the system of any one of examples 1 to 20, wherein the hash codes are stored (e.g., in a memory) as a map of the workspace, wherein each hash code is stored with a semantic classification for the at least one point that is associated with the volumetric space and/or the task state.

Example 22 is an apparatus for representing a workspace of a robot, the apparatus including a sensing means configured to capture an image of the workspace. The apparatus also includes a means for converting the image into a point cloud representation of the workspace. The apparatus also includes a means for determining, for at least one point in the point cloud representation, a hash code that relates a task state to a volumetric space associated with the at least one point. The apparatus also includes a means for determining a motion plan for the robot within the workspace based on the hash code. The apparatus also includes a means for causing the robot to execute the motion plan.

Example 23 is the apparatus of example 22, wherein the volumetric space includes a grouping of one or more points in the point cloud representation, wherein the grouping is represented by a voxel.

Example 24 is the apparatus of example 23, wherein the point cloud representation is divided into a plurality of voxels, wherein the voxel is one of the plurality of voxels, wherein each of the plurality of voxels includes a multilevel octree.

Example 25 is the apparatus of any one of examples 23 or 24, wherein the voxel represents a portion of physical space within the workspace, wherein the voxel is defined by a cartesian coordinate, a bounding box, and a level of the voxel.

Example 26 is the apparatus of any one of examples 22 to 25, wherein the point cloud representation is three-dimensional.

Example 27 is the apparatus of any one of examples 22 to 26, wherein the task state relates to a work requirement of a multilevel task representation framework (e.g., a Petri-Net).

Example 28 is the apparatus of example 27, wherein the multilevel task representation framework includes a multilevel Petri-Net, where the task state is represented by a configuration of mark on the multilevel Petri-Net.

Example 29 is the apparatus of example 28, wherein the multilevel Petri-Net represents input places, output places, and transitions for a task in the workspace, wherein the configuration of marks is on the input places and output places.

Example 30 is the apparatus of any one of examples 28 or 29, wherein the configuration of marks includes a set of input or output requirements within the multilevel Petri-Net.

Example 31 is the apparatus of example 30, wherein the set of input or output requirements is described by a subtask, wherein the subtask is associated with a physical resource needed for the subtask.

Example 32 is the apparatus of any one of examples 22 to 31, wherein the sensing means includes a visual camera, a depth camera, an infrared camera, or a LiDAR sensor.

Example 33 is the apparatus of any one of examples 22 to 32, wherein the motion plan is based directly on the hash code.

Example 34 is the apparatus of any one of examples 22 to 33, wherein the workspace includes a collaboration space as between the robot and a human.

Example 35 is the apparatus of any one of examples 22 to 34, the hash code includes a multi-bit key, wherein a first portion of bits of the multi-bit key represents the task state wherein a second portion of the multi-bit key represents the volumetric space.

Example 36 is the apparatus of example 35, wherein the multi-bit key includes a 64-bit key, wherein the first portion includes 8 bits of the 64-bit key and the second portion includes another 8-bits of the 64-bit key.

Example 37 is the apparatus of any one of examples 22 to 36, wherein the hash code is a unique hash code that uniquely identifies one of the points in the point cloud representation.

Example 38 is the apparatus of any one of examples 22 to 37, wherein the volumetric space has an associated semantic classification.

Example 39 is the apparatus of example 38, wherein the associated semantic classification includes a class token, a task token, and/or a position token of the at least one point.

Example 40 is the apparatus of any one of examples 22 to 39, wherein the means for determining the hash code includes a means for concatenating results from a plurality of functions that are based on a level of a voxel that represents the volumetric space, a cartesian coordinate of the voxel, the task state, a semantic classification associated with the volumetric space, and/or a unique identifier of a physical resource of the workspace.

Example 41 is the apparatus of any one of examples 22 to 40, wherein the motion plan includes a safe trajectory for the robot within the workspace.

Example 42 is the apparatus of any one of examples 22 to 41, wherein the apparatus includes a means for storing (e.g., in a memory) the hash codes as a map of the workspace, wherein each hash code is stored with a semantic classification for the at least one point that is associated with the volumetric space and/or the task state.

Example 43 is a method for representing a workspace of a robot, wherein the method includes capturing an image of the workspace. The method also includes converting the image into a point cloud representation of the workspace. The method also includes determining, for at least one point in the point cloud representation, a hash code that relates a task state to a volumetric space associated with the at least one point. The method also includes determining a motion plan for the robot within the workspace based on the hash code. The method also includes causing the robot to execute the motion plan.

Example 44 is the method of example 43, wherein the volumetric space includes a grouping of one or more points in the point cloud representation, wherein the grouping is represented by a voxel.

Example 45 is the method of example 44, wherein the point cloud representation is divided into a plurality of voxels, wherein the voxel is one of the plurality of voxels, wherein each of the plurality of voxels includes a multilevel octree.

Example 46 is the method of any one of examples 44 or 45, wherein the voxel represents a portion of physical space within the workspace, wherein the voxel is defined by a cartesian coordinate, a bounding box, and a level of the voxel.

Example 47 is the method of any one of examples 43 to 46, wherein the point cloud representation is three-dimensional.

Example 48 is the method of any one of examples 43 to 47, wherein the task state relates to a work requirement of a multilevel task representation framework (e.g., a Petri-Net).

Example 49 is the method of example 48, wherein the multilevel task representation framework includes a multilevel Petri-Net, where the task state is represented by a configuration of mark on the multilevel Petri-Net.

Example 50 is the method of example 49, wherein the multilevel Petri-Net represents input places, output places, and transitions for a task in the workspace, wherein the configuration of marks is on the input places and output places.

Example 51 is the method of any one of examples 49 or 50, wherein the configuration of marks includes a set of input or output requirements within the multilevel Petri-Net.

Example 52 is the method of example 51, wherein the set of input or output requirements is described by a subtask, wherein the subtask is associated with a physical resource needed for the subtask.

Example 53 is the method of any one of examples 43 to 52, wherein the capturing the image includes using a visual camera, a depth camera, an infrared camera, or a LiDAR sensor for capturing the image.

Example 54 is the method of any one of examples 43 to 53, wherein the motion plan is based directly on the hash code.

Example 55 is the method of any one of examples 43 to 54, wherein the workspace includes a collaboration space as between the robot and a human.

Example 56 is the method of any one of examples 43 to 55, the hash code includes a multi-bit key, wherein a first portion of bits of the multi-bit key represents the task state wherein a second portion of the multi-bit key represents the volumetric space.

Example 57 is the method of example 56, wherein the multi-bit key includes a 64-bit key, wherein the first portion includes 8 bits of the 64-bit key and the second portion includes another 8-bits of the 64-bit key.

Example 58 is the method of any one of examples 43 to 57, wherein the hash code is a unique hash code that uniquely identifies one of the points in the point cloud representation.

Example 59 is the method of any one of examples 43 to 58, wherein the volumetric space has an associated semantic classification.

Example 60 is the method of example 59, wherein the associated semantic classification includes a class token, a task token, and/or a position token of the at least one point.

Example 61 is the method of any one of examples 43 to 60, wherein the determining the hash code includes concatenating results from a plurality of functions that are based on a level of a voxel that represents the volumetric space, a cartesian coordinate of the voxel, the task state, a semantic classification associated with the volumetric space, and/or a unique identifier of a physical resource of the workspace.

Example 62 is the method of any one of examples 43 to 61, wherein the motion plan includes a safe trajectory for the robot within the workspace.

Example 63 is the method of any one of examples 43 to 62, wherein the method includes storing (e.g., in a memory) the hash codes as a map of the workspace, wherein each hash code is stored with a semantic classification for the at least one point that is associated with the volumetric space and/or the task state.

Example 64 is a non-transitory computer-readable medium that includes instructions which, if executed, cause one or more processors to capture an image of a workspace of a robot. The instructions also cause the one or more processors to convert the image into a point cloud representation of the workspace. The instructions also cause the one or more processors to determine, for at least one point in the point cloud representation, a hash code that relates a task state to a volumetric space associated with the at least one point. The instructions also cause the one or more processors to determine a motion plan for the robot within the workspace based on the hash code. The instructions also cause the one or more processors to cause the robot to execute the motion plan.

Example 65 is the non-transitory computer-readable medium of example 64, wherein the volumetric space includes a grouping of one or more points in the point cloud representation, wherein the grouping is represented by a voxel.

Example 66 is the non-transitory computer-readable medium of example 65, wherein the point cloud representation is divided into a plurality of voxels, wherein the voxel is one of the plurality of voxels, wherein each of the plurality of voxels includes a multilevel octree.

Example 67 is the non-transitory computer-readable medium of any one of examples 65 or 66, wherein the voxel represents a portion of physical space within the workspace, wherein the voxel is defined by a cartesian coordinate, a bounding box, and a level of the voxel.

Example 68 is the non-transitory computer-readable medium of any one of examples 64 to 67, wherein the point cloud representation is three-dimensional.

Example 69 is the non-transitory computer-readable medium of any one of examples 64 to 68, wherein the task state relates to a work requirement of a multilevel task representation framework (e.g., a Petri-Net).

Example 70 is the non-transitory computer-readable medium of example 69, wherein the multilevel task representation framework includes a multilevel Petri-Net, where the task state is represented by a configuration of mark on the multilevel Petri-Net.

Example 71 is the non-transitory computer-readable medium of example 70, wherein the multilevel Petri-Net represents input places, output places, and transitions for a task in the workspace, wherein the configuration of marks is on the input places and output places.

Example 72 is the non-transitory computer-readable medium of any one of examples 70 or 71, wherein the configuration of marks includes a set of input or output requirements within the multilevel Petri-Net.

Example 73 is the non-transitory computer-readable medium of example 72, wherein the set of input or output requirements is described by a subtask, wherein the subtask is associated with a physical resource needed for the subtask.

Example 74 is the non-transitory computer-readable medium of any one of examples 64 to 73, wherein the sensor includes a visual camera, a depth camera, an infrared camera, or a LiDAR sensor.

Example 75 is the non-transitory computer-readable medium of any one of examples 64 to 74, wherein the motion plan is based directly on the hash code.

Example 76 is the non-transitory computer-readable medium of any one of examples 64 to 75, wherein the workspace includes a collaboration space as between the robot and a human.

Example 77 is the non-transitory computer-readable medium of any one of examples 64 to 76, the hash code includes a multi-bit key, wherein a first portion of bits of the multi-bit key represents the task state wherein a second portion of the multi-bit key represents the volumetric space.

Example 78 is the non-transitory computer-readable medium of example 77, wherein the multi-bit key includes a 64-bit key, wherein the first portion includes 8 bits of the 64-bit key and the second portion includes another 8-bits of the 64-bit key.

Example 79 is the non-transitory computer-readable medium of any one of examples 64 to 78, wherein the hash code is a unique hash code that uniquely identifies one of the points in the point cloud representation.

Example 80 is the non-transitory computer-readable medium of any one of examples 64 to 79, wherein the volumetric space has an associated semantic classification.

Example 81 is the non-transitory computer-readable medium of example 80, wherein the associated semantic classification includes a class token, a task token, and/or a position token of the at least one point.

Example 82 is the non-transitory computer-readable medium of any one of examples 64 to 81, wherein the instructions that cause the one or more processors to determine the hash code includes instructions that cause the one or more processors to concatenate results from a plurality of functions that are based on a level of a voxel that represents the volumetric space, a cartesian coordinate of the voxel, the task state, a semantic classification associated with the volumetric space, and/or a unique identifier of a physical resource of the workspace.

Example 83 is the non-transitory computer-readable medium of any one of examples 64 to 82, wherein the motion plan includes a safe trajectory for the robot within the workspace.

Example 84 is the non-transitory computer-readable medium of any one of examples 64 to 83, wherein the hash codes are stored (e.g., in a memory) as a map of the workspace, wherein each hash code is stored with a semantic classification for the at least one point that is associated with the volumetric space and/or the task state.

While the invention has been particularly described above with reference to specific aspects in the disclosure above, it should be understood by those skilled in the art that various changes in form and detail to those aspects may be made without departing from the spirit and scope of the invention, as defined by the appended claims. The scope of the invention is thus indicated by the appended claims and all changes that are within the meaning and range of equivalency of the claims, are therefore intended to be embraced.

Claimed is:

1. A system for representing a workspace of a robot, the system comprising:
a sensor configured to capture an image of the workspace;
a processor in communication with the sensor, the processor configured to:
convert the image into a point cloud representation of the workspace;
determine, for at least one point in the point cloud representation, a hash code that relates a task state to a volumetric space associated with the at least point;
determine a motion plan for the robot within the workspace based on the hash code; and
cause the robot to execute the motion plan.

2. The system of claim 1, wherein the volumetric space comprises a grouping of one or more points in the point cloud representation, wherein the grouping is represented by a voxel.

3. The system of claim 2, wherein the point cloud representation is divided into a plurality of voxels, wherein the voxel is one of the plurality of voxels, wherein each of the plurality of voxels comprises a multilevel octree.

4. The system of claim 2, wherein the voxel represents a portion of physical space within the workspace, wherein the voxel is defined by a cartesian coordinate, a bounding box, and a level of the voxel.

5. The system of claim 1, wherein the task state relates to a work requirement of a multilevel task representation framework.

6. The system of claim 5, wherein the multilevel task representation framework comprises a multilevel Petri-Net, where the task state is represented by a configuration of mark on the multilevel Petri-Net.

7. The system of claim 6, wherein the configuration of marks comprises a set of input or output requirements within the multilevel Petri-Net.

8. The system of claim 7, wherein the set of input or output requirements is described by a subtask, wherein the subtask is associated with a physical resource needed for the subtask.

9. The system of claim 1, wherein the motion plan is based directly on the hash code.

10. The system of claim 1, the hash code comprises a multi-bit key, wherein a first portion of bits of the multi-bit key represents the task state wherein a second portion of the multi-bit key represents the volumetric space.

11. The system of claim 10, wherein the multi-bit key comprises a 64-bit key, wherein the first portion comprises 8 bits of the 64-bit key and the second portion comprises another 8-bits of the 64-bit key.

12. The system of claim 1, wherein the processor configured to determine the hash code comprises the processor configured to concatenate results from a plurality of functions that are based on a level of a voxel that represents the volumetric space, a cartesian coordinate of the voxel, the task state, a semantic classification associated with the volumetric space, and/or a unique identifier of a physical resource of the workspace.

13. The system of claim 1, wherein the hash codes are stored as a map of the workspace, wherein each hash code is stored with a semantic classification for the at least one point that is associated with the volumetric space and/or the task state.

14. A non-transitory computer-readable medium that includes instructions which, if executed, cause one or more processors to:
capture, via a sensor, an image of a workspace in which a robot operates;
convert the image into a point cloud representation of the workspace;
determine, for at least one point in the point cloud representation, a hash code that relates a task state to a volumetric space associated with the at least one point;
determine a motion plan for the robot within the workspace based on the hash code; and
cause the robot to execute the motion plan.

15. The non-transitory computer-readable medium of claim 14, wherein the hash code is a unique hash code that uniquely identifies one of the points in the point cloud representation.

16. The non-transitory computer-readable medium of claim 14, wherein the volumetric space has an associated semantic classification.

17. The non-transitory computer-readable medium of claim 16, wherein the associated semantic classification comprises a class token, a task token, and/or a position token of the at least one point.

18. An apparatus for representing a workspace of a robot, the apparatus comprising:
a means for capturing an image of the workspace;
a means for converting the image into a point cloud representation of the workspace;
a means for determining, for at least one point in the point cloud representation, a hash code that relates a task state to a volumetric space associated with the at least one point;
a means for determining a motion plan for the robot within the workspace based on the hash code; and
a means for causing the robot to execute the motion plan.

19. The apparatus of claim 18, wherein the point cloud representation is divided into a plurality of voxels, wherein each of the plurality of voxels comprises a multilevel octree.

20. The apparatus of claim 18, wherein each voxel of the plurality of voxels represents a portion of physical space within the workspace, wherein each voxel is defined by a cartesian coordinate, a bounding box, and a level of the voxel.
